(19) United States
(12) Patent Application Publication
(10) Pub. No.: US 2009/0037522 A1
(43) Pub. Date: Feb. 5, 2009

(54) System and Method for Simulating Network Functionality for Demonstration Devices

(75) Inventors: Toshiro OZAWA, San Diego, CA (US); Chris Read, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 11/972,547

(22) Filed: Jan. 10, 2008

Related U.S. Application Data
(60) Provisional application No. 60/963,294, filed on Aug. 2, 2007.

(51) Int. Cl. G06F 15/16

(52) U.S. Cl. 709/203

(57) ABSTRACT

Simulated network functionality is provided to an electronic device used for demonstration purposes when an active network connection is otherwise unavailable. A demonstration mode flag may be detected by the electronic demonstration device upon inserting a local external storage that contains the demonstration mode flag. In response to detecting the demonstration mode flag, the demonstration device may then enter a demonstration mode, where such mode may be characterized by switching the device's default network connection from a standard remote server location to a locally-executing server. Upon detecting a network request from any one of the device's application programs, the local server may receive and respond to the network request using, for example, sample content stored on the local external storage.

### FIELD OF THE INVENTION

The present invention relates in general to simulating a network connection, and in particular to simulating network functionality on an electronic device when an active network connection is otherwise unavailable.

### BACKGROUND

Consumer devices are increasingly being equipped with networking capabilities, either in wired or wireless form, for accessing the Internet, a home network, or the like. Such devices are oftentimes displayed in storefronts or used in various in-store demonstrations. However, it is typically impossible to demonstrate such a device's network functionality since most stores do not have network connectivity available for use with their demonstration products. Accordingly, potential consumers are left to guess how such devices operate in an actual networked environment.

For example, FIG. 1 depicts a typical store 100, which may be an electronics store. The store 100 has a number of demonstration devices 110₁-110ₙ available for its customer to try out. Unfortunately, since there is no available wireless network 120, such customers will not be able to test any network-related functions of the device. As such, the consumer will not have the benefit of assessing the performance and usability of any of the device's network applications.

Thus, what is needed is a system and method for simulating network functionality on an electronic device when an active network connection is otherwise unavailable.

### BRIEF SUMMARY OF THE INVENTION

Disclosed and claimed herein are systems and methods for simulating network functionality on an electronic device used for demonstration purposes. In one embodiment, a method includes detecting a demonstration mode flag stored on a local external storage, and entering a demonstration mode in response to detecting the demonstration mode flag. The method further includes detecting a network request by an application program, and responding to the network request by a local server executing on the electronic device using content from a local external storage.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a typical environment for in-store demonstration devices;

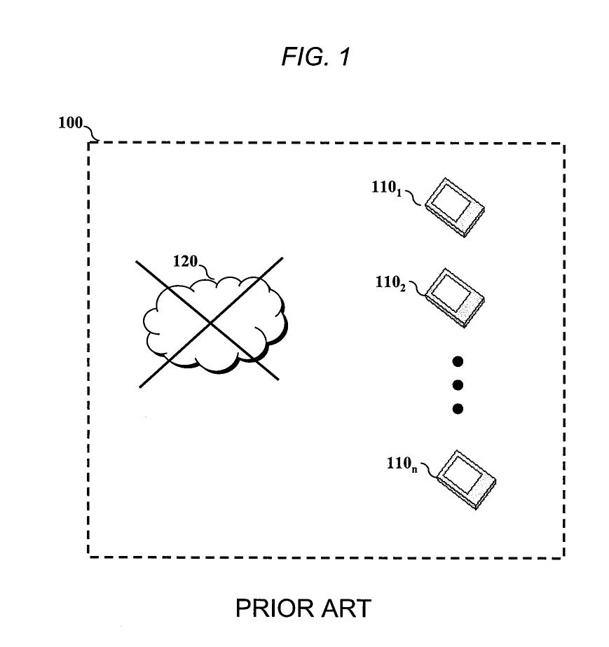

FIG. 2 is a block diagram of an electronic device configured in accordance with the principles of the invention;

FIG. 3 is a block diagram for one embodiment of a system for carrying out one or more aspects of the invention; and

FIG. 4 is one embodiment of a process to be performed by the system of FIG. 3.

### DETAILED DESCRIPTION OF EXEMPLARY EMBODIMENTS

### Disclosure Overview

One aspect of the present disclosure relates to providing network functionality to an electronic device used for demonstration purposes when an active network connection is otherwise unavailable. To that end, a demonstration mode flag, which may be stored on a local external storage, may be detected by a demonstration mode process executing on the electronic device. In one embodiment, this detection may be performed by a software process that automatically detects the demonstration mode flag upon inserting a local external storage that contains the demonstration mode flag into the electronic device. In one embodiment, the demonstration mode flag may comprise particular identifiable software script.

Another aspect of the invention is to have the demonstration device enter a demonstration mode automatically upon detecting the demonstration mode flag. In one embodiment, entering the demonstration mode may be characterized by the switching of the device's default network connection from the standard remote server location to a locally-executing server. The demonstration mode may further be characterized by the execution or start up of the local server.

Still another aspect of the invention is to detect and receive any network request from the device's application programs using the local server, and not the intended remote server which would require the device to have an active network connection. Since the default network connection has been switched to the local server during the demonstration mode, all network-related requests from any application programs may be received by the local server.

As will be described in more detail below, once a network request has been detected and received at the local server, sample content from a local external storage may be used to respond to the request such that the device's application programs remain unaware of the fact that no actual network connection is available.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

The present disclosure relates to simulating network functionality on an electronic device when an actual network connection is otherwise unavailable. In certain embodiments, network functionality may be provided to network-based clients executing on an electronic device, such as a demonstration device in a store environment.

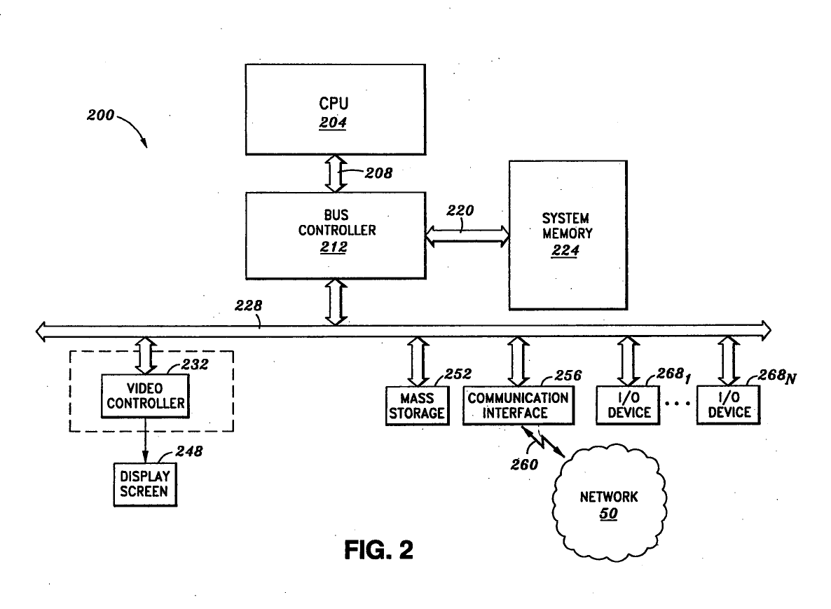

That end, FIG. 2 depicts one embodiment of a simplified schematic of an electronic device capable of implementing one or more aspects of the invention. In particular, electronic device 200 comprises a processor or a central processing unit (CPU) 204, which may include an arithmetic logic unit (ALU) for performing computations, a collection of registers for temporary storage of data and instructions, and a control unit for controlling operation for the electronic device 200. It should be appreciated that CPU 204 need not be limited to microprocessors but may take on other forms such as microcontrollers, digital signal processors, reduced instruction set computers (RISC), application specific integrated circuits, and the like. Similarly, although shown with one CPU 204, it should equally be appreciated that the electronic device 200 may alternatively include multiple processing units.

The CPU 204 is coupled to a bus controller 212 by way of a CPU bus 208. The bus controller 212 may include a memory controller integrated therein, although the memory controller may be external to the bus controller 212. In one embodiment, the system memory 224 may be coupled to the bus control 212 via a memory bus 220, where the system memory 224 may include synchronous dynamic random access memory (SDRAM). System memory 224 may optionally include any additional or alternative high speed memory device or memory circuitry. The bus controller 212 is coupled to a system bus 228 that may be a peripheral component interconnect (PCI) bus, Industry Standard Architecture (ISA) bus, etc. Coupled to the system bus 228 are a graphics controller, a graphics engine or a video controller 232, a mass storage device 252, a communication interface device 256, one or more input/output (I/O) devices 268₁-268_{N}. The video controller 232 may be coupled to a video memory and video BIOS, all of which may be integrated onto a single card or device. The video memory may be used to contain display data for displaying information on the display screen 248, and the video BIOS may include code and video services for controlling the video controller 232. In another embodiment, the video controller 232 may be coupled to the CPU 204 through an advanced graphics port (AGP) bus (not shown).

The mass storage device 252 may include (but not be limited to) a hard disk, floppy disk, CD-ROM, DVD-ROM, tape, high density floppy, high capacity removable media, low capacity removable media, solid state memory device, etc., and combinations thereof. The mass storage device 252 may further include any other mass storage medium. The communication interface device 256 may include a network card, a modem interface, etc. for accessing a wireless network 50 (if it were available) via communications link 260. The I/O devices 268₁-268_{N} may include a keyboard, mouse, audio/sound card, printer, and the like. Additionally, the I/O device 268₁-268_{N} may be a disk drive, such as a compact disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, and/or any combination thereof.

The electronic device 200 may further include system firmware, such as system BIOS, for controlling, among other things, hardware devices in the electronic device 200. The system firmware may include ROM and/or flash (or EEPROM) memory.

As is familiar to those skilled in the art, the electronic device 200 may further include an operating system and at least one application program, which in one embodiment, are loaded into system memory 224 from mass storage device 252. The application programs may include a set of one or more software programs that perform task desired by the user such as, but not limited to, browsing the internet, providing email functionality, playing multimedia files, document management, etc.

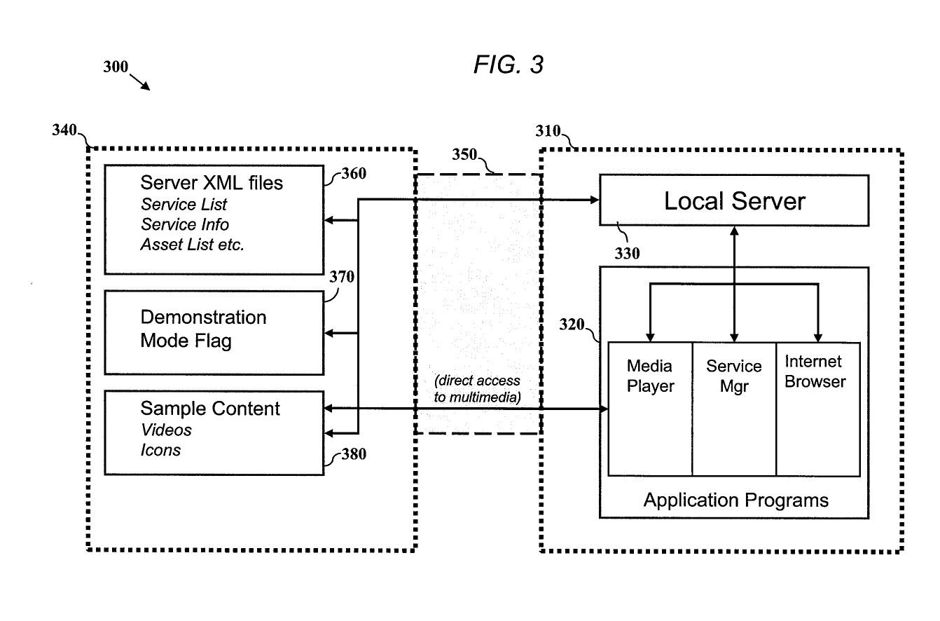

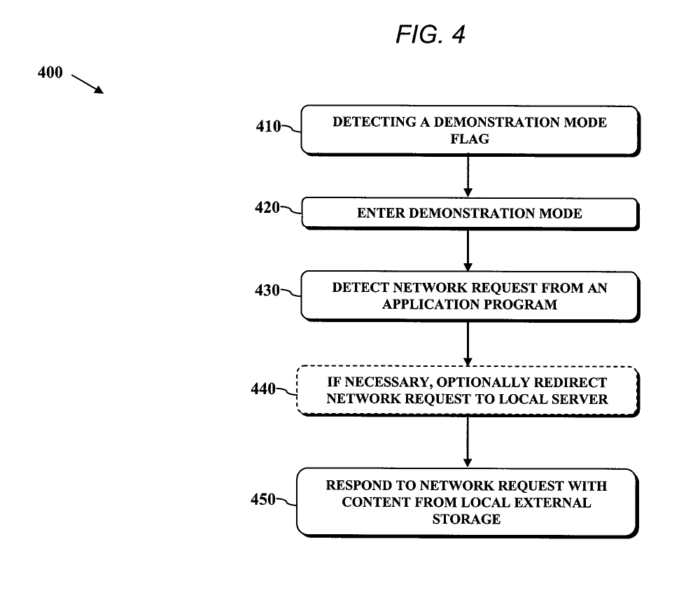

Referring now to FIG. 3, depicted is one embodiment of a system 300 for implementing one or more aspects of the invention. In particular, system 300 comprises an electronic device 310, which in one embodiment may be configured in accordance with the electronic device 200 of FIG. 2. As shown, the electronic device 310 includes one or more application programs 320, which may include a media player, network service manager, and Internet browser. However, it should equally be appreciated that the applications programs 320 may include any application capable of executing on an electronic device. In certain embodiments, at least one of the application programs 320 includes network functionality. In addition, and as will be described in more detail below, the electronic device further includes a local server 330 for simulating a network connection. As will be described in more detail below with reference to the process of FIG. 4, the local server 330 intercept and respond to any network requests from the application programs 320, thereby simulating a network connection and the associated responsiveness of a remote server.

Continuing to refer to FIG. 3, system 300 further includes external local storage 340, which is coupled to the electronic device 310 via interface 350. In one embodiment, local external storage 340 may comprise a so-called thumb drive, and the interface 350 may be a universal serial bus (USB) interface. However, it should be appreciated that the external storage may be any storage, such as a disk drive, such as a compact disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, a flash drive and/or any combination thereof.

Regardless of the type, local external storage 340 is depicted in FIG. 3 as includes a number of server extensible markup language (XML) files 360, a demonstration mode flag 370 and sample media content 380. In certain embodiments, the server XML files 360 may include service lists, service information, asset lists, etc. The XML files 360 may also include metadata related to the content, including dates, times, sources, creators, ratings, durations, descriptions, associations, messages, etc. Finally, sample media content 380 may include music files, pictures, video, audio, icons, graphics and the like.

As will be described in more detail below with reference to the process of FIG. 4, the local server 330 may simulate a network server and the associated responsiveness of a remote server by serving, to the application programs 320, content from the server XML files 360 and/or the sample media content 380 from the local external storage 340.

Referring now to FIG. 4, depicted is one embodiment of a process 400 for implementing one or more embodiments of the invention. In particular, process 400 begins at block 410 with the demonstration mode flag (e.g., flag 370) being detected by the demonstration device in question. In one embodiment, this detection operation may occur automatically upon inserting a local external storage (e.g., local external storage 340) that contains the demonstration mode file. By way of example, in one embodiment the operation of block 410 may comprise detecting the presence of the local external storage and, in response thereto, also automatically detecting the demonstration mode flag on the connected local external storage.

In one embodiment, the demonstration mode flag, which may comprise a software flag or script, may be recognized by a demonstration mode process executing on the device in question. In one embodiment, the demonstration mode process may comprise embedded device software which is dormant or otherwise inactive until the demonstration mode flag is detected.

Process 400 may then continue to block 420 where the device may enter a demonstration mode in response to the detection of the demonstration mode flag by the demonstration mode process. Entering the demonstration mode may be characterized by the switching of the device's default network connection from the standard remote server location to a local server, such as local server 330. This switching operation may be performed by a computer-executable software switch, which may be part of the aforementioned demonstration mode process.

In one embodiment, the local server may comprise a software module executed by the device's processor, wherein the local server is configured to respond to server requests, thereby simulating the responsiveness of a remote server by serving. It should of course be appreciated that entering the demonstration mode may further be characterized by the execution or start up of the local server.

Continuing to refer to FIG. 4, process 400 continues to block 430 with the detection of a network request from an application program (e.g., one of application programs 320) which is also executing on the demonstration device. In certain embodiments this detection operation may be performed by the local server, which by virtue of the aforementioned software switch, should receive all network-related requests from any application programs. However, in other embodiments it may be necessary to redirect the request to the local server (block 440). This may be the case where, for example, the default network server connection was not switched as described above, but where network-related requests are otherwise intercepted (e.g., by the demonstration file or some other background process). By way of non-limiting examples, the types of network requests which may be made by application programs and detected at block 430 may include a browser application request to access a particular uniform resource locator (URL), an email application request to send and/or receive email, a media player request to access online multimedia content, etc.

Regardless of how the application program's request is detected by the local server, once there is a network request detected and received at the local server, process 400 may then continue to block 450 where the local server may then respond to the application's request using sample content from the local external storage (e.g., sample content 380). Depending on the nature of the request, the local server may access and serve, from local external storage, any number of XML files (e.g., server XML files 360), multimedia content (e.g., sample content 380) and the like.

In certain embodiments, the device's application programs are unaware that their network-based requests are being processed by a locally-executing server using locally stored content. Thus, in this fashion potential customers will be able to interact with all of the device's application programs without the need for an active network connection, or for any modifications to be made to the device itself or any of its application programs. The combination of the local server and content on the local external storage may be used to simulate true network connectivity, thereby improving the user's demonstration experience when an active network connection is unavailable.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for simulating network functionality in an electronic device for demonstration purposes comprising:
detecting a demonstration mode flag stored on a local external storage;
entering a demonstration mode in response to detecting the demonstration mode flag;
detecting a network request by an application program; and
responding to the network request by a local server executing on the electronic device using content from a local external storage.

2. The method of claim 1, further comprising executing the application program on the electronic device.

3. The method of claim 1, wherein the demonstration mode flag comprises identifiable software script.

4. The method of claim 1, wherein entering the demonstration mode comprises switching a default network connection to the local server.

5. The method of claim 4, wherein entering the demonstration mode further comprises executing the local server on the electronic device.

6. The method of claim 1, wherein detecting the network request comprises receiving the network request at the local server.

7. The method of claim 1, wherein responding to the network request comprises responding to the network request using the content from the local external storage without the application program detecting that the content is being locally provided.

8. An electronic device comprising:
a memory configured to store a local server module and an application program;
an interface for coupling the electronic device to a local external storage; and
a processor configured to,
detect a demonstration mode flag stored on a local external storage,
enter a demonstration mode in response to detecting the demonstration mode flag,
detect a network request by the application program, and
respond, by the local server module, to the network request using content from the local external storage.

9. The electronic device of claim 8, wherein the processor is further configured to execute the application program on the electronic device.

10. The electronic device of claim 8, wherein the demonstration mode flag comprises identifiable software script.

11. The electronic device of claim 8, wherein the processor is further configured, while in the demonstration mode, to switch a default network connection to the local server.

12. The electronic device of claim 11, wherein the processor is further configured to, while in the demonstration mode, to execute the local server on the electronic device.

13. The electronic device of claim 8, wherein the processor is to detect the network request by at least in part receiving the network request at the local server.

14. The electronic device of claim 8, wherein the processor is to respond to the network request using the content from the local external storage without the application program detecting that the content is being locally provided.

15. A computer program product comprising:
a computer readable medium having computer executable program code embodied therein to simulate network functionality in an electronic device for demonstration purposes, the computer executable program product having:
computer executable program code to detect a demonstration mode flag stored on a local external storage,
computer executable program code to enter a demonstration mode in response to detecting the demonstration mode flag;
computer executable program code to detect a network request by an application program; and
computer executable program code to respond to the network request by a local server executing on the electronic device using content from a local external storage.

16. The computer executable program product of claim 15, further comprising computer executable program code to execute the application program on the electronic device.

17. The computer executable program product of claim 15, wherein the demonstration mode flag comprises identifiable software script.

18. The computer executable program product of claim 15, wherein said computer executable program code to enter the demonstration mode comprises computer executable program code to switch a default network connection to the local server.

19. The computer executable program product of claim 18, wherein said computer executable program code to enter the demonstration mode further comprises computer executable program code to execute the local server on the electronic device.

20. The computer executable program product of claim 15, wherein said computer executable program code to detect the network request comprises computer executable program code to receive the network request at the local server.

21. The computer executable program product of claim 15, wherein said computer executable program code to respond to the network request comprises computer executable program code to respond to the network request using the content from the local external storage without the application program detecting that the content is being locally provided.
